(19) United States
(12) Patent Application Publication
(10) Pub. No.: US 2019/0074620 A1
(43) Pub. Date: Mar. 7, 2019

(54) PLUG CONNECTOR PART WITH A COOLED CONTACT ELEMENT

(71) Applicant: Phoenix Contact E-Mobility GmbH, Schieder-Schwalenberg (DE)

(72) Inventor: Dirk Moseke, Hoexter-Luechtringen (DE)

(21) Appl. No.: 16/082,287

(22) PCT Filed: Mar. 17, 2017
(86) PCT No.: PCT/EP2017/056355

§ 371 Date: Sep. 5, 2018

(30) Foreign Application Priority Data
Mar. 22, 2016 (DE) 10 2016 105 311.2

(51) Int. Cl. H01R 13/00; B60L 11/18; H01R 13/533

(52) U.S. Cl. CPC H01R 13/005; B60L 11/1818; B60L 2230/12; H01R 2201/26; H01R 13/533

(57) ABSTRACT

A plug-in connector part for connection to a mating plug-in connector part includes: at least one contact element for electrically contacting an associated mating contact element of the mating plug-in connector part; and a contact holder, on which the at least one contact element is held, the contact holder having a main body and an insulating casing which encases the main body at least in part and which is comprised of an electrically insulating material, the main body having at least one channel for passage of a coolant.

### CROSS-REFERENCE TO PRIOR APPLICATIONS

This application is a U.S. National Phase application under 35 U.S.C. § 371 of International Application No. PCT/EP2017/056355, filed on Mar. 17, 2017, and claims benefit to German Patent Application No. DE 10 2016 105 311.2, filed on Mar. 22, 2016. The International Application was published in German on Sep. 28, 2017 as WO 2017/162532 under PCT Article 21(2).

### FIELD

The invention relates to a plug-in connector part for connection to a mating plug-in connector part.

### BACKGROUND

A plug-in connector part of this kind comprises at least one contact element for electrically contacting an associated mating contact element of the mating plug-in connector part, and a contact holder on which the at least one contact element is held.

By means of a contact holder, it is possible to hold and fixedly position one or more contact elements, for example, in a housing of the plug-in connector part such that the contact elements form a mating face on a plug-in portion of the plug-in connector part. The contact holder having the contact elements arranged thereon thus forms an assembly that can be attached, preassembled, to the housing of the plug-in connector part such that the installation of the contact elements in the housing is simplified.

A plug-in connector part of this kind can be used in particular as a charging plug or as a charging socket for charging an electrically powered vehicle (also referred to as an electric vehicle). In this case, a cable, for example, is connected to a charging station at one end and has the plug-in connector part in the form of a charging plug at the other end, which plug-in connector part can be inserted into an associated mating plug-in connector part in the form of a charging socket on a vehicle so as to establish an electrical connection between the charging station and the vehicle.

In principle, charging currents can be transmitted as direct currents or alternating currents, charging currents in the form of direct current in particular having a high amperage, for example greater than 200 A or even greater than 300 A or indeed 350 A, it being possible for said charging currents to cause the cable, as well as a plug-in connector part connected to the cable, to heat up.

A charging cable known from DE 10 2010 007 975 B4 has a coolant line which comprises a supply line and a return line for a coolant, therefore allowing a coolant to flow back and forth in the charging cable. In this case, the coolant line in DE 10 2010 007 975 B4 is used to remove heat produced due to energy loss from an energy store of a vehicle, but also to additionally cool the cable itself

In a charging system for charging an electric vehicle, heat is produced not only in the cable by means of which a charging plug is connected to a charging station, for example, but also in the charging plug and in particular within the charging plug, for example in contact elements which allow electrical contact with associated mating contact elements to be established, for example in a charging socket on an electric vehicle, when the charging plug is inserted into the charging socket. Contact elements of this kind, which are made of an electrically conductive metal material, for example a copper material, heat up when a charging current flows via the contact elements, which, in principle, are dimensioned on the basis of the charging current to be transmitted, such that the contact elements have a sufficient current-carrying capacity and the heating of the contact elements is limited. It is essential here that a contact element is dimensioned and designed such that the required currents can be safely transmitted.

However, limits are set on scaling the size of the contact elements against increasing charging current on account of the associated installation space requirements, the weight and the costs. There is therefore a requirement to transmit a high charging current by means of a relatively small contact element.

In a charging system known from WO 2015/119791 A1 for charging an electric vehicle, coolant lines are guided inside a charging cable, by means of which lines heat can also be removed from the region of a plug-in connector part connected to the charging cable.

In a contact element known from U.S. Pat. No. 8,835,782, cooling ribs are arranged on a shaft of the contact element.

### SUMMARY

In an embodiment, the present invention provides a plug-in connector part for connection to a mating plug-in connector part, comprising: at least one contact element configured to electrically contact an associated mating contact element of the mating plug-in connector part; and a contact holder, on which the at least one contact element is held, the contact holder having a main body and an insulating casing which encases the main body at least in part and which is comprised of an electrically insulating material, the main body having at least one channel for passage of a coolant.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a charging system for charging an electric vehicle;

FIG. 2 is a view of a plug-in connector part in the form of a charging plug;

FIG. 3 is a view of an assembly of the plug-in connector part, comprising a contact holder and plug-in portions of the plug-in connector part;

FIG. 4 is a separate view of the assembly of the contact holder;

FIG. 5A is a view of a main body of the contact holder;

FIG. 5B is a view of the main body, together with an insulating casing arranged thereon;

FIG. 6A is a rear view of the main body;

FIG. 6B is a rear view of the main body, together with the insulating casing arranged thereon;

FIG. 7A is a side view of the main body;

FIG. 7B is a side view of the main body, together with the insulating casing arranged thereon;

FIG. 8A is a perspective view of the main body;

FIG. 8B is a perspective view of the main body, together with the insulating casing arranged thereon;

FIG. 9A is a front view of the main body;

FIG. 9B is a front view of the main body, together with the insulating casing arranged thereon;

FIG. 10 is a sectional view along the line A-A according to FIG. 9B;

FIG. 11 is a view of another embodiment of an assembly of a plug-in connector part;

FIG. 12 is a side view of the assembly according to FIG. 11;

FIG. 13 is a front view of the assembly according to FIGS. 11 and 12;

FIG. 14 is a separate view of a contact holder of the assembly;

FIG. 15 is a side view of the contact holder;

FIG. 16 is a front view of the contact holder;

FIG. 17 is a plan view of the contact holder;

FIG. 18 is a view of a channel formed in a main body of the contact holder, together with an insulating casing in the region of fastening points of the main body for fastening contact elements to the contact holder; and

FIG. 19 is a separate view of the channel.

### DETAILED DESCRIPTION

In an embodiment, the present invention provides a plug-in connector part having a contact element which can have a high current-carrying capacity, for example for use in a charging system for charging an electric vehicle.

According to this subject matter, the contact holder comprises a main body and an insulating casing made of an electrically insulating material that encases the main body at least in part, the main body having at least one channel for the passage of a coolant.

Accordingly, the contact holder is used for holding and positioning one or more contact elements, for example in a housing of the plug-in connector part. For example, it is possible to hold two contact elements on the contact holder in the form of load contacts for transmitting direct current. An additional contact element may form a PE contact for contacting a neutral conductor. Further contact elements used as signal contacts for transmitting control signals may be provided.

In addition to the function of mechanically positioning the contact elements, the contact holder is also used to cool in particular the contact elements which conduct large currents during operation and which may therefore heat up during operation. For this purpose, at least one channel is formed in the main body of the contact holder; a coolant, for example a liquid coolant (water, for example) or a gaseous coolant (air, for example) can flow through said channel such that heat can be absorbed in the main body and can be transferred away from the main body.

The main body is preferably formed of a highly thermally conductive material. For example, the main body may be made of a metal material, for example aluminum, for example as a die-cast aluminum part. The main body therefore makes it possible to guide heat away from the contact elements arranged thereon and transfer it to the coolant flowing through the channel, and it is therefore possible to transfer heat away from the contact holder by means of the coolant.

The main body forms, for example, one or more fastening points to which one or more contact elements can be mechanically securely attached. The main body, made of metal for example, is thus sufficiently mechanically stable that the contact elements are held on the contact holder in a secure and reliable manner by means of the structure provided by the main body.

To electrically insulate the contact elements with respect to the main body in the process, the main body is encased by the insulating casing in the region of the fastening points thereof in particular, i.e. the main body is covered such that the contact elements do not rest directly on the main body in an electrically conductive manner, but rather the contact elements are electrically insulated with respect to the main body by means of the insulating casing. If, for example, two contact elements that form load contacts for transmitting a direct current are arranged on the contact holder, said load contacts are each electrically insulated with respect to the main body by means of the insulating casing such that the contact elements cannot be shorted to one another via the main body.

In the present case, the encasing of the main body by the insulating casing at least in part is understood to mean that the insulating casing is arranged on the main body at least in portions and covers the main body at least in portions such that the main body is insulated. The encasing here does not have to be complete. In addition, the insulating casing does not necessarily have to cover the main body on the outside, but rather the casing may for example also be arranged in a hole, or the like, that forms a fastening point for a contact element.

In one embodiment, a fastening point may be formed for fastening a contact element to the main body by means of a hole in the main body. In this case, the insulating casing covers the main body e.g. on the inside of the hole such that the insulating casing insulatingly encases the main body in the region of the hole such that the contact element does not electrically contact the main body. The insulating casing is therefore used as an insulation layer between the contact element inserted in the hole and the main body.

In a further embodiment, the channel extends helically around an associated fastening point. In this case, the channel is formed in the main body and allows the heat produced in the main body to be absorbed on account of the extension of said channel around the fastening point. On account of the helical extension of the channel around the fastening point, the coolant flowing through the channel allows heat to be directly absorbed from a contact element attached to the fastening point, and to be transferred away from the contact element to an effective degree.

While load contacts are intended to be electrically insulated with respect to the main body made of metal, a contact element used for connecting a neutral conductor is preferably in electrical contact with the main body. This PE contact is therefore directly attached to a fastening point formed on the main body, without the insulating casing electrically insulating the PE contact with respect to the main body. This is advantageous in that secure earthing takes place via the PE contact if the insulation of a load contact with respect to the main body is damaged. In this case, it is possible to identify damage to the insulation of a load contact by carrying out a fault current test before the start of a charging process; as a result, a charging process may not even be started or may be interrupted if damage occurs.

The insulating casing is preferably made of an electrically insulating plastics material, for example PVC or PA66. For example, to form the insulating casing, the main body may be overmolded with plastics material at least in part such that the main body is covered by the insulating casing at least in portions and electrical insulation of the main body is thus provided in regions.

The insulating casing is preferably made of a plastics material that is advantageously thermally conductive and can provide a high electric strength. For example, a plastics material may be used that provides an electric strength in a range of between 10 kV/mm and 15 kV/mm. This makes it possible, by means of a wall thickness of a few tenths of a millimeter, for example, to achieve sufficient insulation of the contact elements that form the load contacts with respect to the main body.

In addition to its insulating function, the insulating casing may also have a mechanical load-bearing function. For example, the insulating casing may form an insertion sleeve in the region of a fastening point for fastening a contact element, in which sleeve the at least one contact element is inserted by means of a shaft portion to be connected to a load line. The shaft portion can therefore project into the insertion sleeve. The load line is, for example, crimped to the shaft portion to establish electrical contact; the crimping point can be accommodated within the insertion sleeve.

The main body forms a channel through which a coolant flows during operation such that heat can be absorbed in the main body and transferred away from the main body. In one embodiment, the main body may for example have two connections, one of which is used to guide coolant into the channel and the other is used to guide it out of the channel again. Coolant lines that are connected to the connections therefore provide a coolant circuit through the main body, which allows heat to be transferred away from the plug-in connector part.

The coolant lines are preferably laid in a cable which is connected to the plug-in connector part and in which one or more load lines are also accommodated to supply electrical current to the contact elements of the plug-in connector part.

It is also conceivable and possible to provide more than one channel in the cooling body such that various flow paths that make it possible to absorb heat in the main body are provided within the main body. In this connection, it is also conceivable to provide more than two connections on the main body such that, for example, more than two coolant lines can also be connected to the main body.

In an alternative embodiment, it is also conceivable and possible to provide just one connection on the main body for connecting a coolant line. In this case, a gaseous fluid may for example flow into the channel via the single connection and exit the channel at another location, without being guided back via a coolant line.

The main body, together with the channel formed therein, may be formed by means of selective sintering, for example. Selective laser sintering (SLS) is understood to mean an additive manufacturing method in which three-dimensional structures are produced from a powdered starting material (preferably a metal material) by sintering using a laser. In this process, the workpiece is built up layer-by-layer, and it is therefore possible in principle, by means of the effect of the laser beams, to produce any desired three-dimensional shape, in particular having a channel formed therein.

A plug-in connector part of the type described herein can be used, for example, as a charging plug or a charging socket within the context of a charging system for charging an electric vehicle. A plug-in connector part of this kind may, for example, be arranged on a charging cable and connected to a charging station via the charging cable. A charging plug of this kind may be inserted, for example, in a charging socket on an electric vehicle to transmit charging currents between the charging station and the electric vehicle.

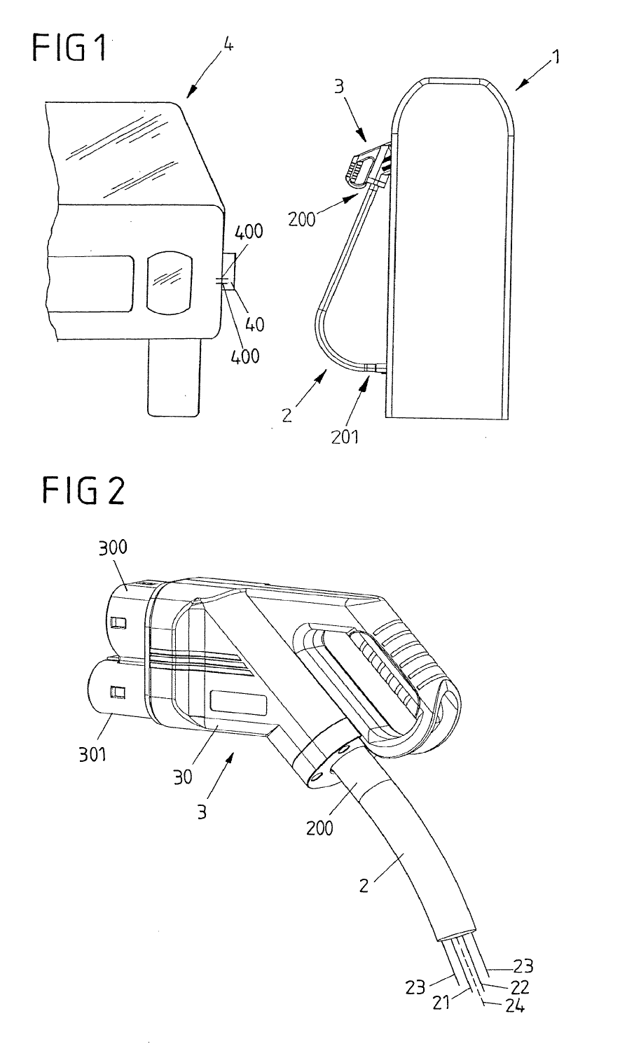

FIG. 1 shows a charging station 1 which is used for charging an electrically powered vehicle 4 (also referred to as an electric vehicle). The charging station 1 is designed to provide a charging current in the form of an alternating current or a direct current and has a cable 2, one end 201 of which is connected to the charging station 1 and another end 200 of which is connected to a mating plug-in connector part 3 in the form of a charging plug.

As can be seen in the enlarged view according to FIG. 2, the mating plug-in connector part 3 has plug-in portions 300, 301 on a housing 30, by means of which portions the plug-in connector part 3 can be brought into engagement in a plug-in manner with an associated mating plug-in connector part 40 in the form of a charging socket on the vehicle 4.

In this way, the charging station 1 can be electrically connected to the vehicle 4 in order to transmit charging currents from the charging station 1 to the vehicle 4.

In order to allow rapid charging of the electric vehicle 4, e.g. in the context of a fast charging process, the transmitted charging currents have a high amperage, e.g. greater than 200 A, optionally even of the magnitude of 350 A or more. On account of such high charging currents, thermal losses occur on the cable 2 and also on the plug-in connector part 3 and the charging socket 40, which thermal losses can lead to the cable 2, the plug-in connector part 3 and the charging socket 40 heating up.

The plug-in connector part 3 comprises a plurality of contact elements on the plug-in portions 300, 301 thereof. For example, two contact elements for transmitting a charging current in the form of a direct current may be arranged on the plug-in portion 301, while contact elements for providing a grounding PE contact and signal contacts for transmitting control signals may be arranged on the plug-in portion 300.

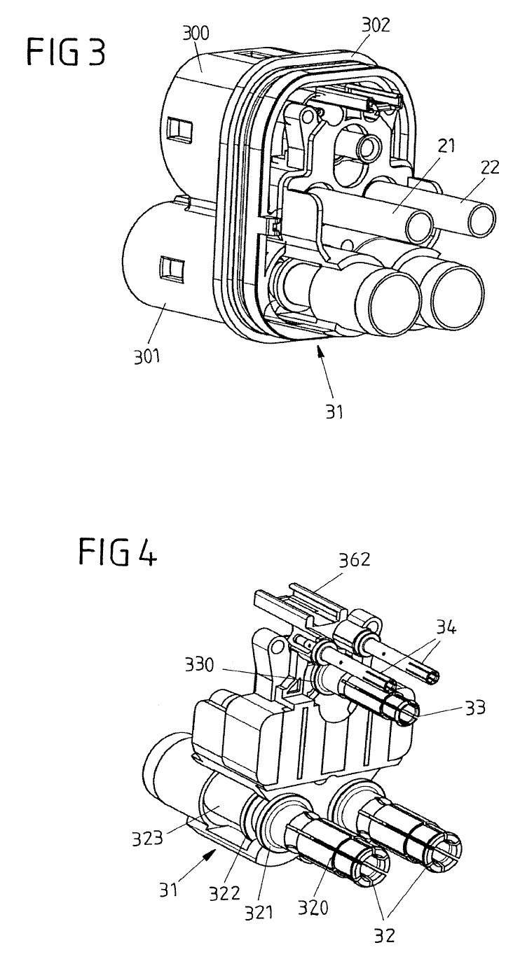

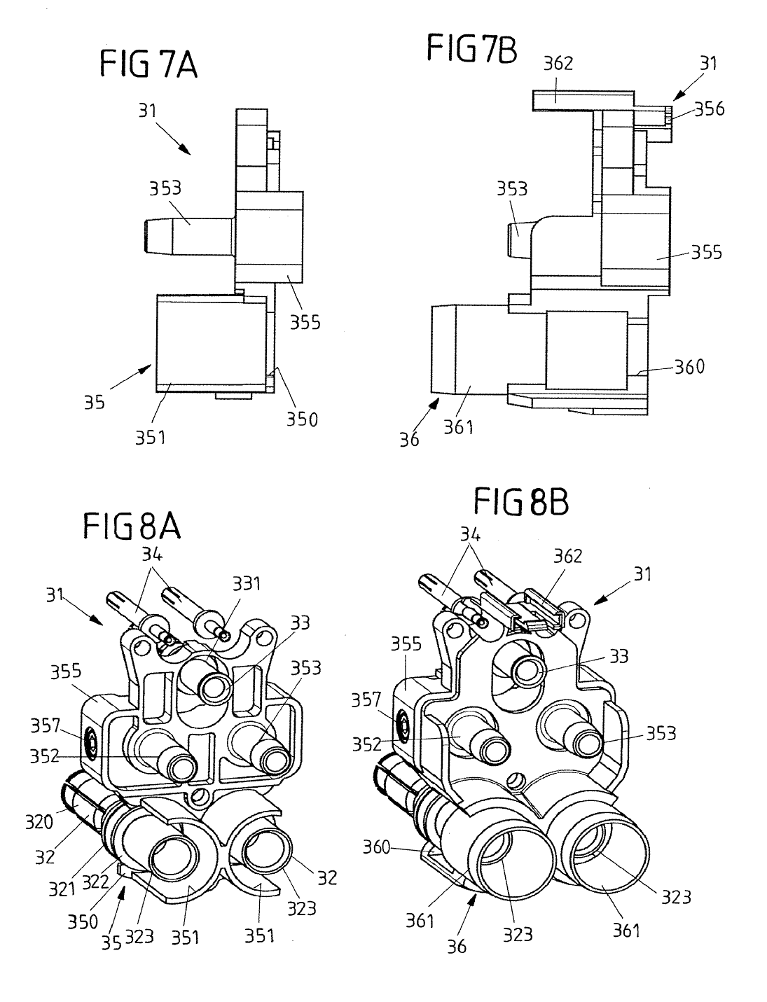

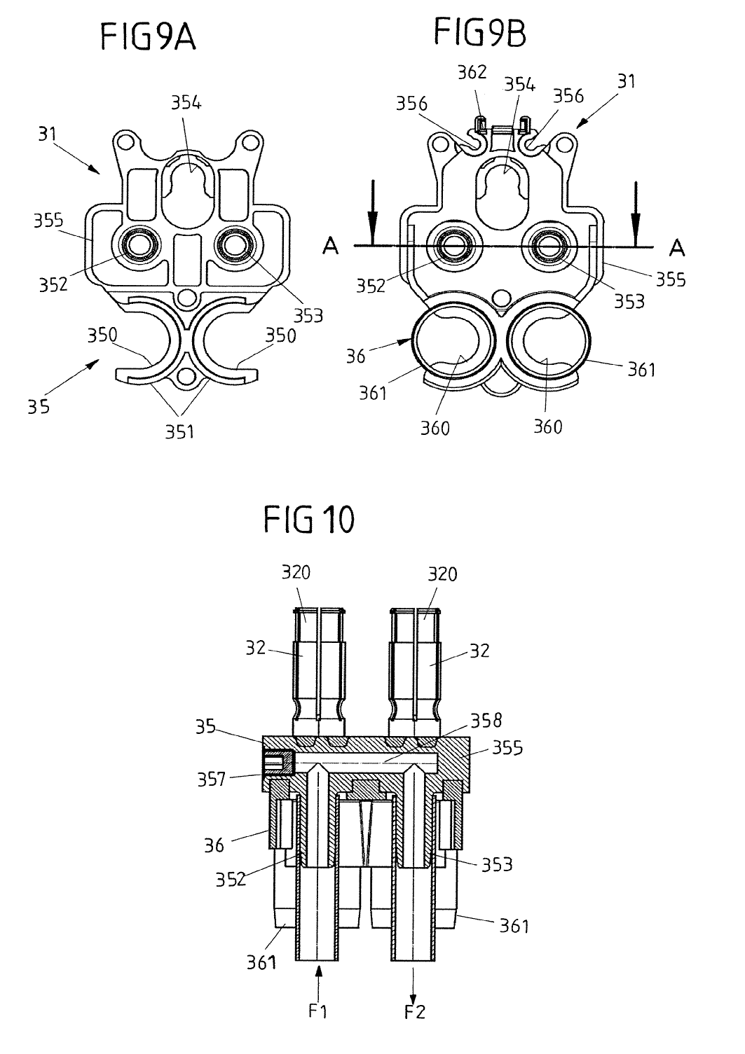

FIGS. 3 to 10 show one embodiment of an assembly of the plug-in connector part 3, by means of which assembly contact elements 32, 33, 34 are positioned within the housing 30 of the plug-in connector part 3 such that the contact elements 32, 33, 34 project into the plug-in portions 300, 301 and, when the plug-in connector part 3 is inserted into the associated mating plug-in connector part 40 in the form of a charging socket, can electrically contact associated mating contact elements 400 of the mating plug-in connector part 40 (see the mating contact elements 400 shown schematically in FIG. 1).

The plug-in portions 300, 301 are formed on a housing part 302, as shown in FIG. 3. A contact holder 31 is attached to the housing part 302, on which contact holder, as shown in FIG. 4, the contact elements 32, 33, 34 are held and are thus positioned within the plug-in portions 300, 301.

The contact holder 31 is used, firstly, to mechanically hold the contact elements 32, 33, 34 within the housing 30 of the plug-in connector part 3. Secondly, the contact holder 31 has a cooling function for absorbing and removing heat in particular from the contact elements 32 that form load contacts, contact portions 320 of which are located within the lower plug-in portion 301 in the form of contact sockets and which are used to transmit a charging current in the form of a direct current, such that cooling is provided on the contact elements 32.

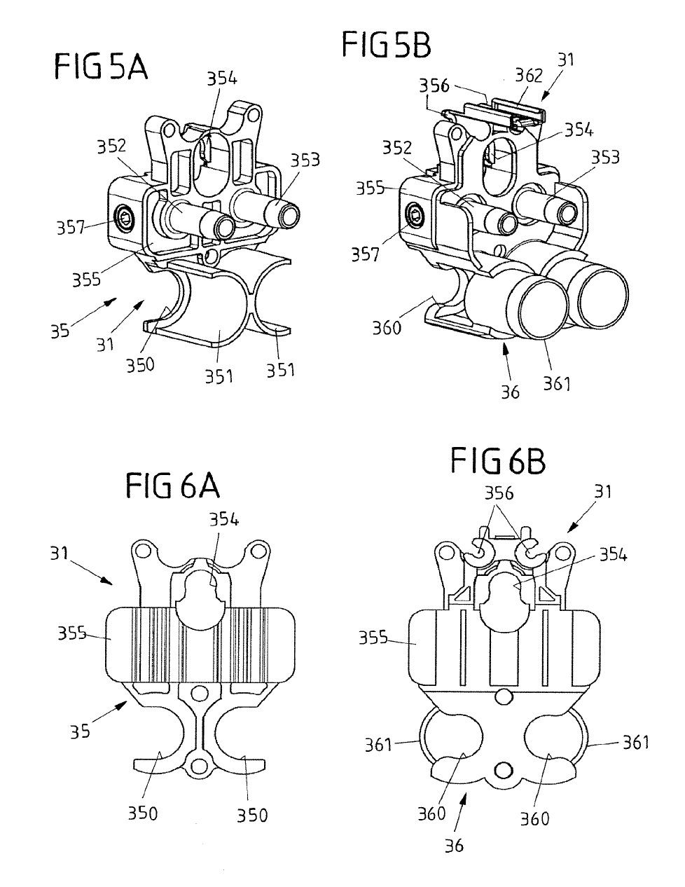

As can be seen from the views in FIG. 5A, 5B to 9A and 9B, the contact holder 31 is formed by a main body 35 that provides the load-bearing structure of the contact holder 31 and by an insulating casing 36 that encases the main body 35 at least in part.

In the embodiment shown, the main body 35 (shown in isolation in FIG. 5A-9A) is made of a metal material, for example as a die-cast aluminum part, and is highly thermally conductive.

The insulating casing 36 is formed by overmolding the main body 35 by means of a plastics material, for example. The insulating casing 36 encases the main body 35 in part, in particular in the regions in which electrical insulation of the main body 35, for example with respect to contact elements 32 arranged thereon, is intended to be provided.

Two adjacent fastening points 350 are formed on the main body 35, which are used for receiving the contact elements 32 that form the load contacts and allow the contact elements 32 to be mechanically securely fastened to the contact holder 31.

A fastening point 354 for receiving a contact element 33 that forms a PE contact is also formed on the main body 35.

Both the contact elements 32 and the contact element 33 can be attached to the respective associated fastening points 350, 354 such that the contact elements 32, 33 each receive a fastening point 350, 354, formed by a rib, between two axially mutually spaced collars 321, 322, 330, 331, and the contact elements 32, 33 are thus held in particular axially on the contact holder 31.

While the fastening points 350 for the contact elements 32 are enveloped by a covering 360 formed by the insulating casing 36, the fastening point 354 is uncovered. Therefore, if the contact elements 32 that form the load contacts are attached to the contact holder 31, the contact elements 32 are electrically insulated with respect to the main body 35 by means of the covering 360. By contrast, the contact element 33 that forms the PE contact rests directly against the main body 35, and is therefore in electrical contact with the main body 35.

The electrical insulation between the contact elements 32 and the main body 35 is necessary to prevent an electrical short circuit via the main body 35 between the contact elements 32, via which charging currents are transmitted during charging. The insulation provided by the covering 360 of the insulating casing 36 here has sufficient electric strength (>1,000 V), for example by the insulating casing 36 being made of a plastics material, for example PVC or PA66, which has an electric strength of between 10 kV/mm and 15 kV/mm. A covering 360 having a wall thickness of a few tenths of a millimeter is thus sufficient in itself to electrically insulate the main body 35 in the region of the fastening points 350 with respect to the contact elements 32 that form the load contacts.

As can be seen e.g. in FIG. 5B, the covering 360 on the fastening points 350 allows the contact elements 32 to be wrapped around by an angle of more than 180°. Upon fastening to the fastening points 350, the contact elements 32 are thus interlockingly connected to the contact holder 31 and are consequently interlockingly held on the contact holder 31.

Since the contact element 33 that forms the PE contact is not electrically insulated with respect to the main body 35, the main body 35 is involved in the electrical grounding. Therefore, if the covering 360 is damaged at one of the fastening points 350 and the electrical insulation of one of the contact elements 32 with respect to the main body 35 is therefore impaired, this can be identified by carrying out a fault current test on the charging station 1 side; as a result, a charging process may not even be started or may be interrupted if it has already begun.

A neutral conductor 24 that extends in the charging cable 2 is connected to the contact element 33 that forms the PE contact such that the contact element 33 is grounded via the neutral conductor 24.

Semi-cylindrical portions 351 project from the fastening points 350 on the main body 35, which portions are adjoined by insertion sleeves 361 of the insulating casing 36. Shaft portions 323 of the contact elements 32 are inserted into the insertion sleeves 361 such that crimping points that allow the load lines 23 to be connected to the shaft portions 323 of the contact elements 32 are accommodated within the insertion sleeves 361.

Furthermore, contact elements 34 are arranged on the contact holder 31, which form signal contacts for transmitting control signals. To fasten said contact elements 34 to the contact holder 31, the insulating casing 36 forms fastening points 356 (see in particular FIG. 6B) that allow the signal contacts 34 to be held on the contact holder 31.

The contact element 33 that forms the PE contact and the contact elements 34 that form the signal contacts are arranged in the upper plug-in portion 300 and are connected to associated mating contact elements 400 of the mating plug-in connector part 40 when the plug-in connector part 3 is inserted into the mating plug-in connector part 40.

As can be seen in FIG. 8B, for example, the insulating casing 36 also forms a fastening element 362 in the form of latch device that allows the contact holder 31 to be fixed within the housing 30, for example.

The contact holder 31 forms a load-bearing structure for positioning the contact elements 32, 33, 34. In addition, as mentioned, said contact holder is also used to cool in particular the contact elements 32 that form the load contacts. For this purpose, a (cuboid) body portion 355 is formed on the main body 35, in which portion a channel 358 is formed. The channel 358 is fluidically connected to connections 352, 353 in the form of attachment pieces, which are formed on the main body 35 and to each of which a coolant line 21, 22 can be connected such that it is possible to feed a coolant into the channel 358 and also guide it out of the channel 358 again via the coolant lines 21, 22.

As can be seen from the sectional view according to FIG. 10, the channel 358 extends transversely in the body portion 355. The channel 358 is for example made in the main body 35, which is made of a die-cast aluminum part, in the form of a blind hole and is closed to the outside by means of a closure element 357 in the form of a screw element. Since the channel 358 is fluidically connected to the connections 352, 353, a coolant (for example, a liquid coolant (water) or a gaseous coolant (air)) can flow into the channel 358 in a flow direction F1 and flow out of the channel 358 in a flow direction F2.

As shown schematically in FIG. 2, the coolant lines 21, 22 are laid within the charging cable 2 and extend between the charging station 1 and the plug-in connector part 3. Within the plug-in connector part 3, the coolant lines 21, 22, as shown in FIGS. 3 and 10, for example, are connected to connections 352, 353 of the main body 35, which provides a diversion for the coolant and thus diverts a coolant supplied via a coolant line 21 and guides said coolant back through the other coolant line 22.

Since the covering 360 of the insulating casing 36 may be thin-walled in the region of the fastening points 350, heat can be efficiently absorbed from the contact elements 32, conducted via the main body 35, which is made of a highly thermally conductive material, and transferred away by means of the coolant flowing through the channel 358. By means of the contact holder 31, the contact elements 32 that form the load contacts are cooled to an effective degree, and said contact elements 32 can thus be prevented from overheating.

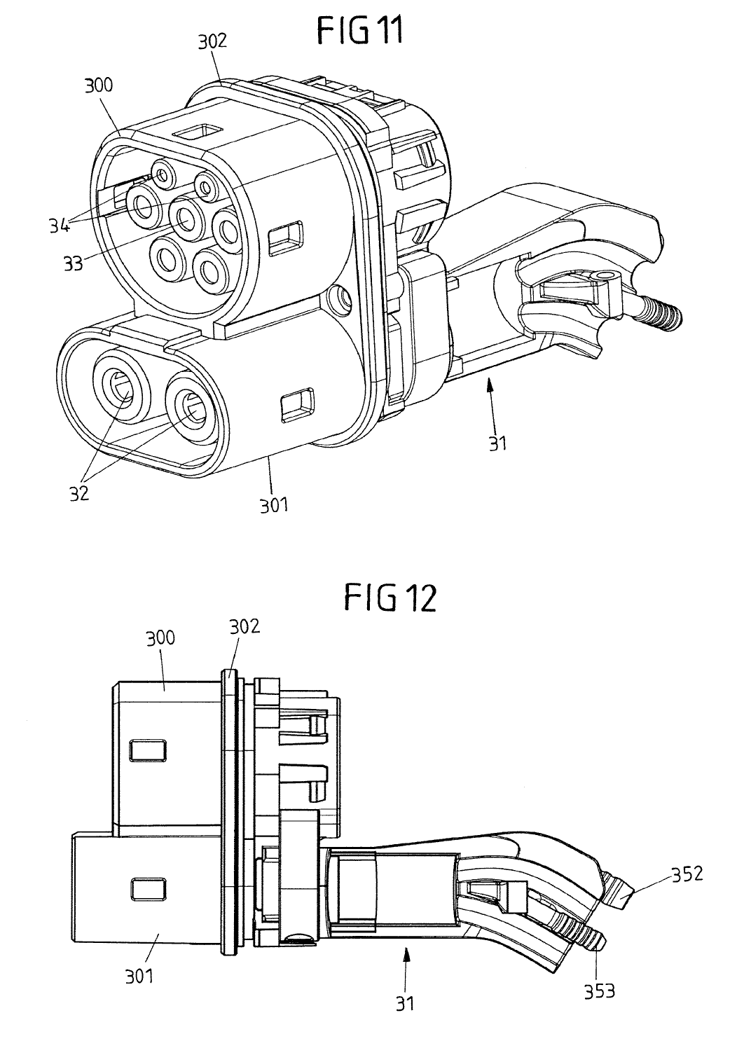

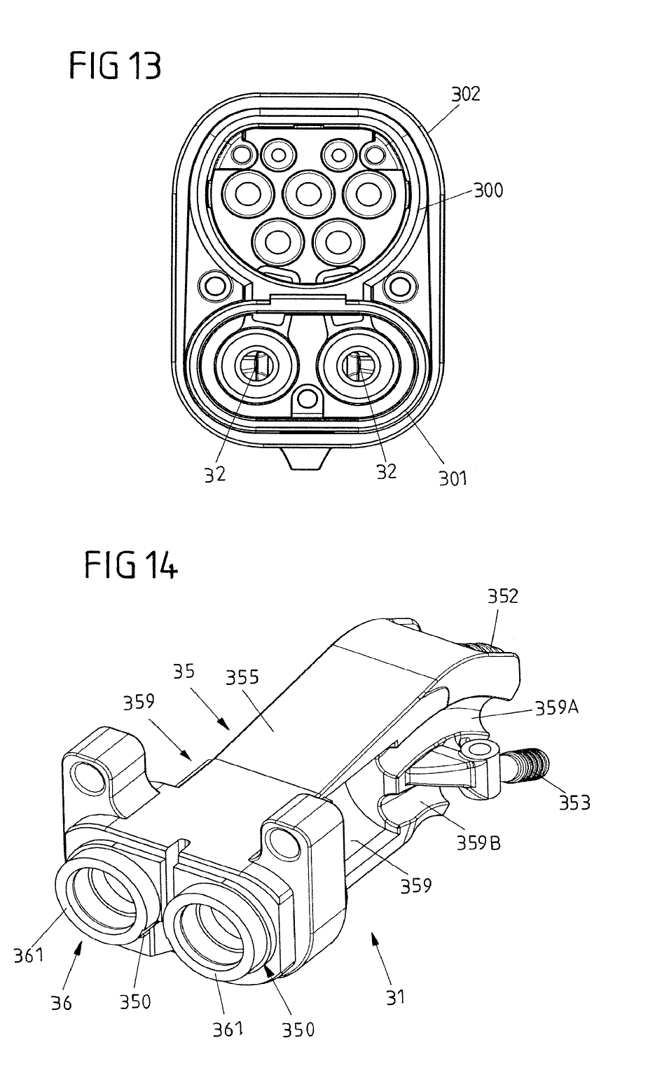

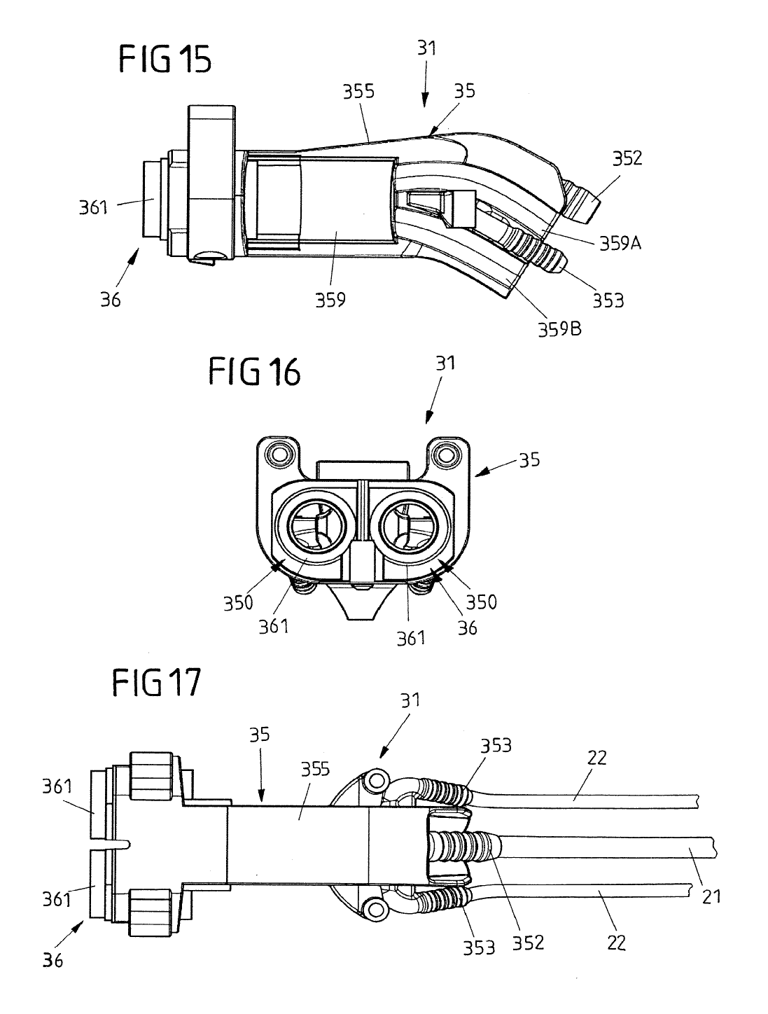

FIGS. 11 to 19 show another embodiment of an assembly of a plug-in connector part 3, by means of which assembly contact elements 32, 33, 34 are positioned within the housing 30 of the plug-in connector part 3.

In the embodiment according to FIGS. 11 to 19, a contact holder 31 is provided on which the contact elements 32 that are used as load contacts and associated with the lower plug-in portion 301 are arranged and held. The contact holder 31 is used, firstly, for mechanical positioning on the housing part 302 of the plug-in connector part 3 but also, secondly, for electrical insulation and for transferring heat away from the contact elements 32.

As can be seen in FIG. 14, for example, the contact holder 31 is formed by a main body 35 that is encased by two segments of an insulating casing 36 in the region of fastening points 350 for attaching the contact elements 32 on the contact holder 31. In this embodiment, the fastening points 350 are formed by holes in the main body 35, which is made of a metal material.

Insertion sleeves 361 formed by the insulating casing 36 are arranged within said holes, by means of which sleeves the contact elements 32 are held on the contact holder 31 and which also provide electrical insulation between the contact elements 32 and the main body 35.

On a body portion 355 of the main body 35 facing away from the housing part 302, recesses 359 are formed on both sides of the main body 35 and in a manner each associated with a fastening point 350; the contact elements 32 protrude (if they are held on the contact holder 31) into said recesses, and electrical load lines are connected to the contact elements 32 in the region thereof. The recesses 359 each adjoin the associated fastening point 350, which is formed by a hole, and thus create space to the rear of the fastening point 350.

Here the load lines are guided towards the relevant contact element 32 via guide portions 359A, 359B (see FIG. 14), each contact element 32 being associated with two load lines. By using two separate load lines (via which the same current is guided and which have the same potential) for each contact element 32, the total surface area of the load lines is increased to improve heat removal.

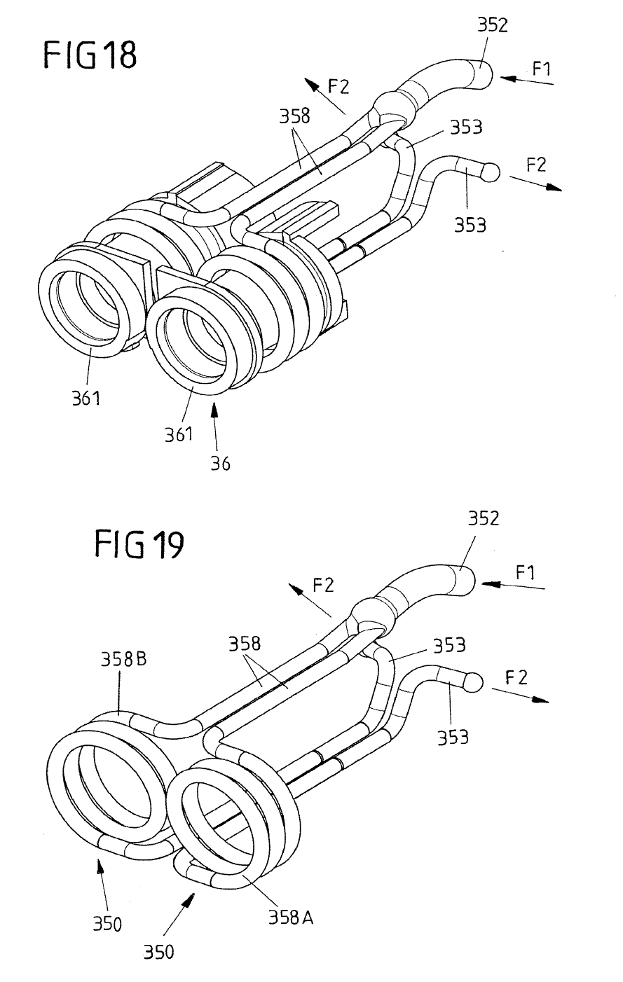

In the main body 35, which is made of a metal material, a channel 358 is formed, as shown in FIGS. 18 and 19. The channel 358 is integrally formed in the main body 35 and extends, in separate channel portions 358A, 358B, helically around the fastening points 350 and the insertion sleeves 361 formed therein by the insulating casing 36, such that coolant can flow around the fastening points 350 and the insertion sleeves 361 formed therein, in order to absorb heat from the fastening points 350 and contact elements 32 attached thereto and to be able to transfer said heat away from the fastening points 350.

The channel 358 formed within the main body 35 has a connection 352 that is used to feed coolant in a flow direction F1 (see FIGS. 18 and 19). From the connection 352, the channel 358 branches to form two separate channel portions 358A, 358B that are each associated with a fastening point 350. Each channel portion 358A, 358B has a separate connection 353 that acts as an outlet for carrying the coolant away in a flow direction F2.

As shown schematically in FIG. 17, for example, flow lines 21, 22 are connected to the connections 352, 353, which lines extend within the charging cable 2 and via which coolant is supplied or carried away.

The main body 35 in the embodiment according to FIGS. 11 to 19 is produced by means of a selective laser sintering method, for example. In selective laser sintering, which is an additive manufacturing method, the main body 35 is produced layer-by-layer from a (metal) powder material, together with the channel 358 that is formed therein. In principle, selective laser sintering allows complex three-dimensional structures to be formed.

The concept underpinning the invention is not limited to the above-described embodiments, but in principle can also be implemented in entirely different embodiments.

By means of the contact holder, one or more contact elements are held on the plug-in connector part. Firstly, the contact holder allows positioning within a housing of the plug-in connector part. Secondly, cooling for at least some of the contact elements is provided.

It is possible here to form a plurality of different flow channels in the main body of the contact holder such that a coolant can flow through the main body along different flow paths. In this way, it is possible for coolant to flow around closely positioned contact elements that are to be cooled, such that heat can be absorbed from the contact elements to an effective degree.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 charging station
2 charging cable
200, 201 end
21, 22 coolant line
23 load line
24 neutral conductor
3 charging plug
30 housing
300, 301 plug-in portion
302 housing part
31 contact holder
32 contact element (load contact)
320 contact portion (socket)
321, 322 collar
323 shaft portion
33 PE contact
330, 331 collar
34 signal contact
35 main body
350 fastening point
351 semi-cylindrical portion
352, 353 connection (attachment piece)
354 attachment point
355 body portion
356 fastening point
357 closure element
358 channel
358A, 358B channel portion
359 recess
359A, 359B guide portion
36 insulating casing
360 covering
361 insertion sleeve
362 fastening element
4 vehicle
40 charging socket
400 mating contact element
F1, F2 flow direction

1. A plug-in connector part for connection to a mating plug-in connector part, comprising:
at least one contact element configured to electrically contact an associated mating contact element of the mating plug-in connector part; and
a contact holder, on which the at least one contact element is held, the contact holder having a main body and an insulating casing which encases the main body at least in part and which is comprised of an electrically insulating material, the main body having at least one channel for passage of a coolant.

2. The plug-in connector part according to claim 1, wherein the main body is comprised of a thermally conductive material.

3. The plug-in connector part according to claim 1, wherein the main body forms at least one fastening point for the at least one contact element, in the region of which fastening point the insulating casing encases the main body such that the at least one contact element arranged on the contact holder is electrically insulated with respect to the main body.

4. The plug-in connector part according to claim 3, wherein the at least one fastening point is formed by a hole in the main body, the insulating casing covering the main body on an inside of the hole.

5. The plug-in connector part according to claim 3, wherein the at least one channel extends helically around the at least one fastening pointer.

6. The plug-in connector part according to claim 1, wherein a contact element configured for connecting a neutral conductor is in electrical contact with the main body.

7. The plug-in connector part according to claim 1, wherein the insulating casing is comprised of a plastics material.

8. The plug-in connector part according to claim 1, wherein the main body is overmolded with plastics material at least in part in order to form the insulating casing.

9. The plug-in connector part according to claim 1, wherein the insulating casing forms at least one insertion sleeve, in which the at least one contact element is inserted using a shaft portion to be connected to a load line.

10. The plug-in connector part according to claim 1, wherein the main body comprises at least one connection which is fluidically connected to the at least one channel and is configured to connect a coolant line to the contact holder.

11. The plug-in connector part according to claim 1, wherein the main body comprises a first connection configured to connect a first coolant line and a second connection configured to connect a second coolant line such that the coolant is guided into the channel via the first connection and is guided out of the channel via the second connection.

12. The plug-in connector part according to claim 1, wherein the main body, together with the at least one channel formed therein, is produced using selective laser sintering.

13. The plug-in connector part according to claim 2, wherein thermally conductive material comprises a metal material.

14. The plug-in connector part according to claim 13, wherein the metal material comprises aluminum.
